(19) United States
(12) Patent Application Publication
(10) Pub. No.: US 2024/0004534 A1
(43) Pub. Date: Jan. 4, 2024

(54) CLICK AND SWAP

(71) Applicant: Content Square SAS, Paris (FR)

(72) Inventors: Sylvain Rousseau, Paris (FR); Mahdi Maiche, Paris (FR); Mengzhu Liu, Paris (FR); Othmane Bentaleb, Paris (FR)

(21) Appl. No.: 18/216,962

(22) Filed: Jun. 30, 2023

Related U.S. Application Data
(60) Provisional application No. 63/357,396, filed on Jun. 30, 2022.

(51) Int. Cl. G06F 3/04845

(52) U.S. Cl. CPC G06F 3/04845

(57) ABSTRACT

Systems and techniques may be used for providing a user interface in a layout edit mode. The user interface may include a dashboard having a visualization component. An example technique may include identifying a user interaction with a first visualization component on the user interface, displaying a location control interface overlaid on the first visualization component, receiving a user selection of a control mechanism of the location control interface, and determining that a second visualization component of the plurality of visualization components is in a location corresponding to where the user selection would cause the first visualization component to move. The example technique may include selecting a movement interaction rule of a plurality of movement interaction rules to apply to the first visualization component, and moving the first visualization component based on the movement interaction rule, the location, and the user selection.

### CLAIM OF PRIORITY

This application claims the benefit of priority to U.S. Provisional Application No. 63/357,396 filed Jun. 30, 2022, titled “CLICK AND SWAP,” which is hereby incorporated herein by reference in its entirety.

### BACKGROUND

Web commerce has become a nearly universal way to sell products. Managing web commerce websites is often done by a team of people, who use web analytics to make design, structural, and interactive choices for the web commerce websites. Sales data from a website may be used to determine whether a product is successful. However, the sales data does not tell the entire story, nor does it provide sufficient data to make proactive decisions.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some nonlimiting examples are illustrated in the figures of the accompanying drawings in which:

FIG. 1 is a diagrammatic representation of a networked environment in which the present disclosure may be deployed in accordance with some examples.

FIG. 2 is a diagrammatic representation of an experience analytics system that has both client-side and server-side functionality in accordance with some examples.

FIG. 3 is a diagrammatic representation of a data structure as maintained in a database in accordance with some examples.

FIG. 4 is a flowchart for a process in accordance with some examples.

FIG. 5 is a diagrammatic representation of a machine in the form of a computer system within which a set of instructions may be executed for causing the machine to perform any one or more of the methodologies discussed herein in accordance with some examples.

FIG. 6 is a block diagram showing a software architecture within which examples may be implemented in accordance with some examples.

FIGS. 7-10 are example user interfaces showing the systems and techniques described herein, in accordance with some examples.

FIGS. 11-15 are example block diagrams showing movement interaction rules in accordance with some examples.

### DETAILED DESCRIPTION

Systems and techniques described herein provide a user interface that includes a customizable dashboard with visualization components that are movable via control mechanisms. The visualization components may be moved according to movement interaction rules, which provide for a seamless and less frustrating user experience. The movement interaction rules may include one or more techniques for handling movement of a visualization component when the movement causes the visualization component to interact with another visualization component.

The systems and techniques described herein provide controls for user movement of visualization component. The controls may include a selectable indication to move a visualization component up, down, left, or right on a dashboard. The controls may allow a user to insert a new row, expand or shrink a visualization component (e.g., horizontally, vertically, or both), add a new visualization component, remove a visualization component, or the like. The controls may be activated on the user interface when the user interface is in a layout edit mode, and may otherwise be hidden. In some examples, when the layout edit mode is active, interactions with aspects of the visualization component themselves may be disabled, while the controls are usable.

In an example, the visualization components present information, metrics, indicators, or the like related to website traffic, conversions, attractiveness, etc., related to a merchant website having one or more products for sale. The visualization components may provide information related to a product, a set of products (e.g., a zone having multiple products), a merchant, or the like.

The dashboard provided on the user interface is customizable by a user, and prevents issues related to drag and drop operations that are present in typical user interfaces. The click-based or tap-based selectable controls may provide a more accessible dashboard, since the visualization components may be moved without dragging them (a process that may be challenging for those with visual or physical difficulties). The dashboard may be more precise than typical user interfaces, which may prevent accidental movement, accidental selection of an incorrect visualization component, or display issues with a user interface.

### Networked Computing Environment

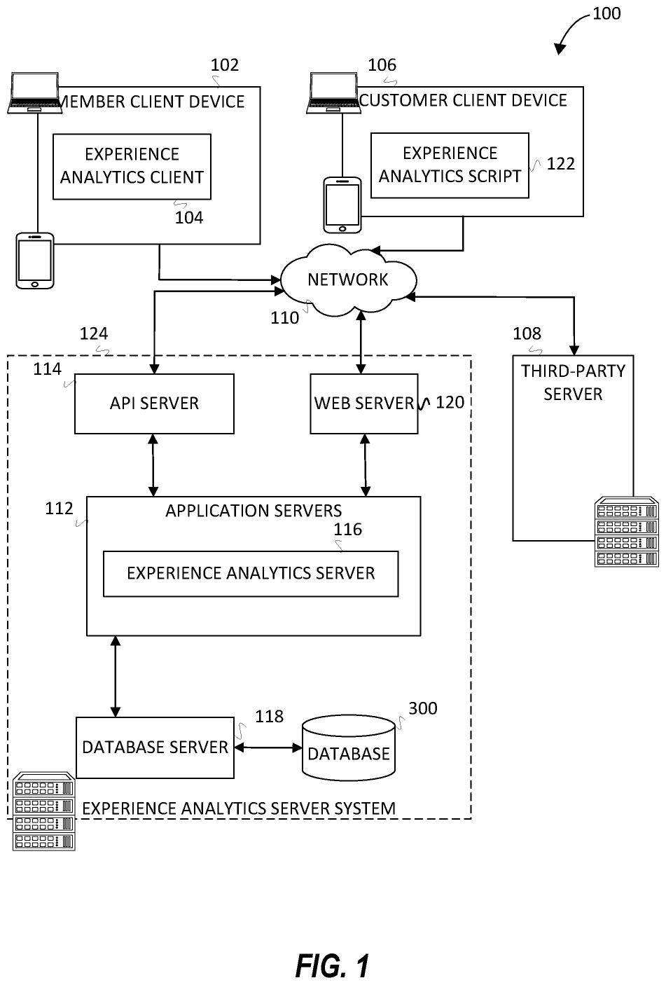

FIG. 1 is a block diagram showing an example experience analytics system 100 that analyzes and quantifies the user experience of users navigating a client's website, mobile websites, and applications. The experience analytics system 100 can include multiple instances of a member client device 102, multiple instances of a customer client device 106, and multiple instances of a third-party server 108.

The member client device 102 is associated with a client of the experience analytics system 100, where the client that has a website hosted on the client's third-party server 108. For example, the client can be a retail store that has an online retail website that is hosted on a third-party server 108. An agent of the client (e.g., a web administrator, an employee, etc.) can be the user of the member client device 102.

Each of the member client devices 102 hosts a number of applications, including an experience analytics client 104. Each experience analytics client 104 is communicatively coupled with an experience analytics server system 124 and third-party servers 108 via a network 110 (e.g., the Internet). An experience analytics client 104 can also communicate with locally-hosted applications using Applications Program Interfaces (APIs).

The member client devices 102 and the customer client devices 106 can also host a number of applications including Internet browsing applications (e.g., Chrome, Safari, etc.). The experience analytics client 104 can also be implemented as a platform that is accessed by the member client device 102 via an Internet browsing application or implemented as an extension on the Internet browsing application.

Users of the customer client device 106 can access client's websites that are hosted on the third-party servers 108 via the network 110 using the Internet browsing applications. For example, the users of the customer client device 106 can navigate to a client's online retail website to purchase goods or services from the website. While the user of the customer client device 106 is navigating the client's website on an Internet browsing application, the Internet browsing application on the customer client device 106 can also execute a client-side script (e.g., JavaScript (.*js)) such as an experience analytics script 122. In one example, the experience analytics script 122 is hosted on the third-party server 108 with the client's website and processed by the Internet browsing application on the customer client device 106. The experience analytics script 122 can incorporate a scripting language (e.g., a.*js file or a .json file).

In certain examples, a client's native application (e.g., ANDROID™ or IOS™ Application) is downloaded on the customer client device 106. In this example, the client's native application including the experience analytics script 122 is programmed in JavaScript leveraging a Software Development Kit (SDK) provided by the experience analytics server system 124. The SDK includes Application Programming Interfaces (APIs) with functions that can be called or invoked by the client's native application.

In one example, the experience analytics script 122 records data including the changes in the interface of the website being displayed on the customer client device 106, the elements on the website being displayed or visible on the interface of the customer client device 106, the text inputs by the user into the website, a movement of a mouse (or touchpad or touch screen) cursor and mouse (or touchpad or touch screen) clicks on the interface of the website, etc. The experience analytics script 122 transmits the data to experience analytics server system 124 via the network 110. In another example, the experience analytics script 122 transmits the data to the third-party server 108 and the data can be transmitted from the third-party server 108 to the experience analytics server system 124 via the network 110.

An experience analytics client 104 is able to communicate and exchange data with the experience analytics server system 124 via the network 110. The data exchanged between the experience analytics client 104 and the experience analytics server system 124, includes functions (e.g., commands to invoke functions) as well as payload data (e.g., website data, texts reporting errors, insights, merchandising information, adaptability information, images, graphs providing visualizations of experience analytics, session replay videos, zoning and overlays to be applied on the website, etc.).

The experience analytics server system 124 supports various services and operations that are provided to the experience analytics client 104. Such operations include transmitting data to and receiving data from the experience analytics client 104. Data exchanges to and from the experience analytics server system 124 are invoked and controlled through functions available via user interfaces (UIs) of the experience analytics client 104.

The experience analytics server system 124 provides server-side functionality via the network 110 to a particular experience analytics client 104. While certain functions of the experience analytics system 100 are described herein as being performed by either an experience analytics client 104 or by the experience analytics server system 124, the location of certain functionality either within the experience analytics client 104 or the experience analytics server system 124 may be a design choice. For example, it may be technically preferable to initially deploy certain technology and functionality within the experience analytics server system 124 but to later migrate this technology and functionality to the experience analytics client 104 where a member client device 102 has sufficient processing capacity.

Turning now specifically to the experience analytics server system 124, an Application Program Interface (API) server 114 is coupled to, and provides a programmatic interface to, application servers 112. The application servers 112 are communicatively coupled to a database server 118, which facilitates access to a database 300 that stores data associated with experience analytics processed by the application servers 112. Similarly, a web server 120 is coupled to the application servers 112, and provides web-based interfaces to the application servers 112. To this end, the web server 120 processes incoming network requests over the Hypertext Transfer Protocol (HTTP) and several other related protocols.

The Application Program Interface (API) server 114 receives and transmits message data (e.g., commands and message payloads) between the member client device 102 and the application servers 112. Specifically, the Application Program Interface (API) server 114 provides a set of interfaces (e.g., routines and protocols) that can be called or queried by the experience analytics client 104 or the experience analytics script 122 in order to invoke functionality of the application servers 112. The Application Program Interface (API) server 114 exposes to the experience analytics client 104 various functions supported by the application servers 112, including generating information on errors, insights, merchandising information, adaptability information, images, graphs providing visualizations of experience analytics, session replay videos, zoning and overlays to be applied on the website, etc.

The application servers 112 host a number of server applications and subsystems, including for example an experience analytics server 116. The experience analytics server 116 implements a number of data processing technologies and functions, particularly related to the aggregation and other processing of data including the changes in the interface of the website being displayed on the customer client device 106, the elements on the website being displayed or visible on the interface of the customer client device 106, the text inputs by the user into the website, a movement of a mouse (or touchpad) cursor and mouse (or touchpad) clicks on the interface of the website, etc. received from multiple instances of the experience analytics script 122 on customer client devices 106. The experience analytics server 116 implements processing technologies and functions, related to generating user interfaces including information on errors, insights, merchandising information, adaptability information, images, graphs providing visualizations of experience analytics, session replay videos, zoning and overlays to be applied on the website, etc. Other processor and memory intensive processing of data may also be performed server-side by the experience analytics server 116, in view of the hardware requirements for such processing.

### System Architecture

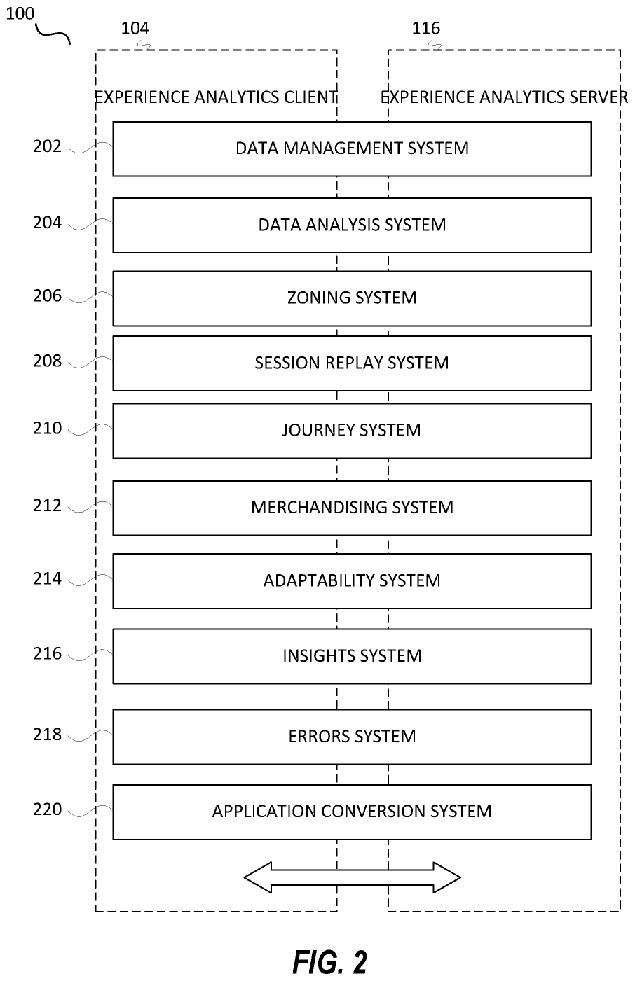

FIG. 2 is a block diagram illustrating further details regarding the experience analytics system 100 according to some examples. Specifically, the experience analytics system 100 is shown to comprise the experience analytics client 104 and the experience analytics server 116. The experience analytics system 100 embodies a number of subsystems, which are supported on the client-side by the experience analytics client 104 and on the server-side by the experience analytics server 116. These subsystems include, for example, a data management system 202, a data analysis system 204, a zoning system 206, a session replay system 208, a journey system 210, a merchandising system 212, an adaptability system 214, an insights system 216, an errors system 218, and an application conversion system 220.

The data management system 202 is responsible for receiving functions or data from the member client devices 102, the experience analytics script 122 executed by each of the customer client devices 106, and the third-party servers 108. The data management system 202 is also responsible for exporting data to the member client devices 102 or the third-party servers 108 or between the systems in the experience analytics system 100. The data management system 202 is also configured to manage the third-party integration of the functionalities of experience analytics system 100.

The data analysis system 204 is responsible for analyzing the data received by the data management system 202, generating data tags, performing data science and data engineering processes on the data.

The zoning system 206 is responsible for generating a zoning interface to be displayed by the member client device 102 via the experience analytics client 104. The zoning interface provides a visualization of how the users via the customer client devices 106 interact with each element on the client's website. The zoning interface can also provide an aggregated view of in-page behaviors by the users via the customer client device 106 (e.g., clicks, scrolls, navigation). The zoning interface can also provide a side-by-side view of different versions of the client's website for the client's analysis. For example, the zoning system 206 can identify the zones in a client's website that are associated with a particular element in displayed on the website (e.g., an icon, a text link, etc.). Each zone can be a portion of the website being displayed. The zoning interface can include a view of the client's website. The zoning system 206 can generate an overlay including data pertaining to each of the zones to be overlaid on the view of the client's website. The data in the overlay can include, for example, the number of views or clicks associated with each zone of the client's website within a period of time, which can be established by the user of the member client device 102. In one example, the data can be generated using information from the data analysis system 204.

The session replay system 208 is responsible for generating the session replay interface to be displayed by the member client device 102 via the experience analytics client 104. The session replay interface includes a session replay that is a video reconstructing an individual user's session (e.g., visitor session) on the client's website. The user's session starts when the user arrives at the client's website and ends upon the user's exit from the client's website. A user's session when visiting the client's website on a customer client device 106 can be reconstructed from the data received from the user's experience analytics script 122 on customer client devices 106. The session replay interface can also include the session replays of a number of different visitor sessions to the client's website within a period of time (e.g., a week, a month, a quarter, etc.). The session replay interface allows the client via the member client device 102 to select and view each of the session replays. In one example, the session replay interface can also include an identification of events (e.g., failed conversions, angry customers, errors in the website, recommendations or insights) that are displayed and allow the user to navigate to the part in the session replay corresponding to the events such that the client can view and analyze the event.

The journey system 210 is responsible for generating the journey interface to be displayed by the member client device 102 via the experience analytics client 104. The journey interface includes a visualization of how the visitors progress through the client's website, page-by-page, from entry onto the website to the exit (e.g., in a session). The journey interface can include a visualization that provides a customer journey mapping (e.g., sunburst visualization). This visualization aggregates the data from all of the visitors (e.g., users on different customer client devices 106) to the website, and illustrates the visited pages and in order in which the pages were visited. The client viewing the journey interface on the member client device 102 can identify anomalies such as looping behaviors and unexpected drop-offs. The client viewing the journey interface can also assess the reverse journeys (e.g., pages visitors viewed before arriving at a particular page). The journey interface also allows the client to select a specific segment of the visitors to be displayed in the visualization of the customer journey.

The merchandising system 212 is responsible for generating the merchandising interface to be displayed by the member client device 102 via the experience analytics client 104. The merchandising interface includes merchandising analysis that provides the client with analytics on the merchandise to be promoted on the website, optimization of sales performance, the items in the client's product catalog on a granular level, competitor pricing, etc. The merchandising interface can, for example, comprise graphical data visualization pertaining to product opportunities, category, brand performance, etc. For instance, the merchandising interface can include the analytics on conversions (e.g., sales, revenue) associated with a placement or zone in the client website.

The adaptability system 214 is responsible for creating accessible digital experiences for the client's website to be displayed by the customer client devices 106 for users that would benefit from an accessibility-enhanced version of the client's website. For instance, the adaptability system 214 can improve the digital experience for users with disabilities, such as visual impairments, cognitive disorders, dyslexia, and age-related needs. The adaptability system 214 can, with proper user permissions, analyze the data from the experience analytics script 122 to determine whether an accessibility-enhanced version of the client's website is needed, and can generate the accessibility-enhanced version of the client's website to be displayed by the customer client device 106.

The insights system 216 is responsible for analyzing the data from the data management system 202 and the data analysis system 204 surface insights that include opportunities as well as issues that are related to the client's website. The insights can also include alerts that notify the client of deviations from a client's normal business metrics. The insights can be displayed by the member client devices 102 via the experience analytics client 104 on a dashboard of a user interface, as a pop-up element, as a separate panel, etc. In this example, the insights system 216 is responsible for generating an insights interface to be displayed by the member client device 102 via the experience analytics client 104. In another example, the insights can be incorporated in another interface such as the zoning interface, the session replay, the journey interface, or the merchandising interface to be displayed by the member client device 102.

The errors system 218 is responsible for analyzing the data from the data management system 202 and the data analysis system 204 to identify errors that are affecting the visitors to the client's website and the impact of the errors on the client's business (e.g., revenue loss). The errors can include the location within the user journey on the website and the page that adversely affects (e.g., causes frustration for) the users (e.g., users on customer client devices 106 visiting the client's website). The errors can also include causes of looping behaviors by the users, in-page issues such as unresponsive calls to action and slow loading pages, etc. The errors can be displayed by the member client devices 102 via the experience analytics client 104 on a dashboard of a user interface, as a pop-up element, as a separate panel, etc. In this example, the errors system 218 is responsible for generating an errors interface to be displayed by the member client device 102 via the experience analytics client 104. In another example, the insights can be incorporated in another interface such as the zoning interface, the session replay, the journey interface, or the merchandising interface to be displayed by the member client device 102.

The application conversion system 220 is responsible for the conversion of the functionalities of the experience analytics server 116 as provided to a client's website to a client's native mobile applications. For instance, the application conversion system 220 generates the mobile application version of the zoning interface, the session replay, the journey interface, the merchandising interface, the insights interface, and the errors interface to be displayed by the member client device 102 via the experience analytics client 104. The application conversion system 220 generates an accessibility-enhanced version of the client's mobile application to be displayed by the customer client devices 106.

The data management system 202 may store pageviews or unit prices corresponding to out of stock items. The data analysis system 204 may use the stored pageviews or unit prices, for example along with an average conversion rate, to determine a loss indicator for the out of stock item. The average conversion rate may be stored at the data management system 202. The loss indicator may be output from the experience analytics server 116, for example to a user device for display.

### Data Architecture

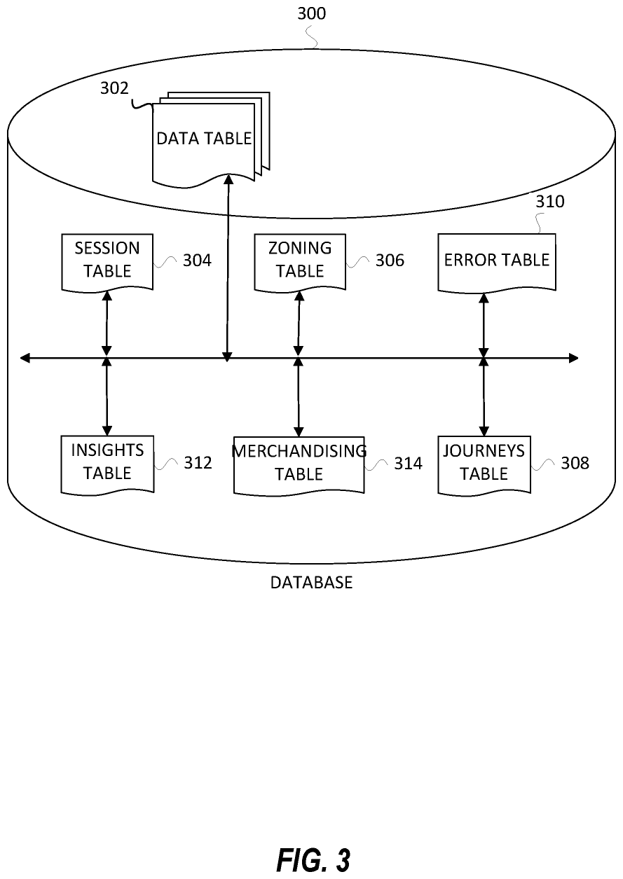

FIG. 3 is a schematic diagram illustrating database 300, which may be stored in the database 300 of the experience analytics server 116, according to certain examples. While the content of the database 300 is shown to comprise a number of tables, it will be appreciated that the data could be stored in other types of data structures (e.g., as an object-oriented database).

The database 300 includes a data table 302, a session table 304, a zoning table 306, an error table 310, an insights table 312, a merchandising table 314, and a journeys table 308.

The data table 302 stores data regarding the websites and native applications associated with the clients of the experience analytics system 100. The data table 302 can store information on the contents of the website or the native application, the changes in the interface of the website being displayed on the customer client device 106, the elements on the website being displayed or visible on the interface of the customer client device 106, the text inputs by the user into the website, a movement of a mouse (or touchpad or touch screen) cursor and mouse (or touchpad or touch screen) clicks on the interface of the website, etc. The data table 302 can also store data tags and results of data science and data engineering processes on the data. The data table 302 can also store information such as the font, the images, the videos, the native scripts in the website or applications, etc.

The session table 304 stores session replays for each of the client's websites and native applications.

The zoning table 306 stores data related to the zoning for each of the client's websites and native applications including the zones to be created and the zoning overlay associated with the websites and native applications.

The journeys table 308 stores data related to the journey of each visitor to the client's website or through the native application.

The error table 310 stores data related to the errors generated by the errors system 218 and the insights table 312 stores data related to the insights generated by the insights table 312.

The merchandising table 314 stores data associated with the merchandising system 212. For example, the data in the merchandising table 314 can include the product catalog for each of the clients, information on the competitors of each of the clients, the data associated with the products on the websites and applications, the analytics on the product opportunities and the performance of the products based on the zones in the website or application, etc.

### Process

Although the described flowcharts can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

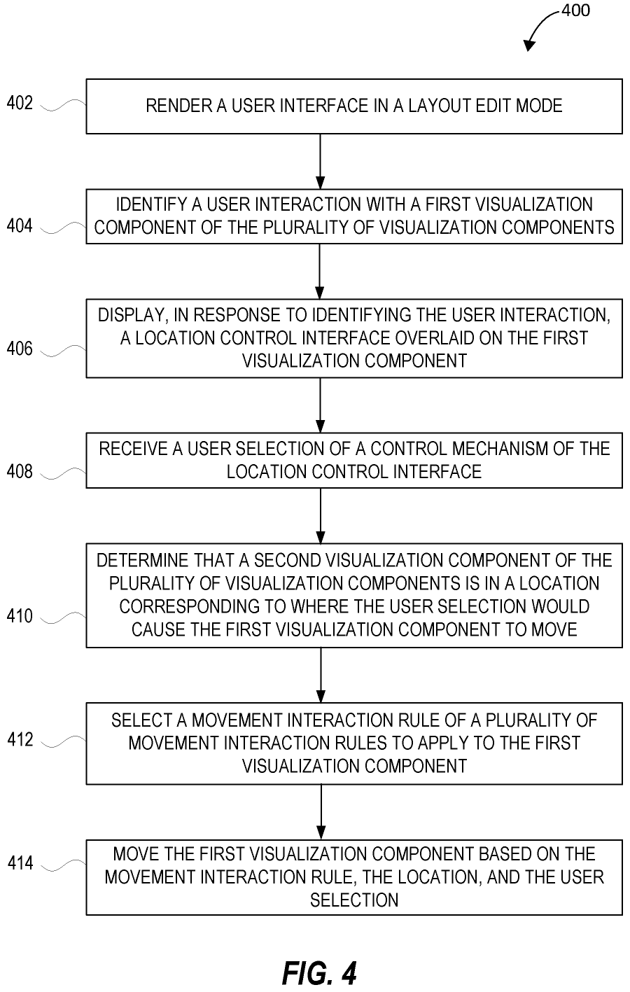

FIG. 4 is a schematic diagram illustrating a process 400, for providing a dashboard having a plurality of visualization components. The process 400 includes an operation 402 to render a user interface in a layout edit mode, the user interface including the dashboard. The process 400 includes an operation 404 to identify a user interaction with a first visualization component of the plurality of visualization components. The user interaction may include a mouse hover, a long press on a touchscreen, a right mouse click, or the like.

The process 400 includes an operation 406 to display, in response to identifying the user interaction, a location control interface overlaid on the first visualization component. The process 400 includes an operation 408 to receive a user selection of a control mechanism of the location control interface. The control mechanism may include a directional arrow, a set of directional arrows (e.g., up, down, left right), or the like. The user selection may include a left mouse click, a touch selection on a touchscreen, or the like. The process 400 includes an operation 410 to determine that a second visualization component of the plurality of visualization components is in a location corresponding to where the user selection would cause the first visualization component to move.

The process 400 includes an operation 412 to select a movement interaction rule of a plurality of movement interaction rules to apply to the first visualization component. The movement interaction rule may specify a number of equally sized column locations for placement of the plurality of visualization components. In an example, selection of a resize control mechanism of the location control interface may cause the first visualization component to be sized to occupy at least two of the equally sized column locations. In this example, the resize control mechanism may be disabled on the location control interface when the second visualization component occupies one of the at least two of the equally sized column locations. The plurality of movement interaction rules may include one or more of swapping the first visualization component with the second visualization component, passing the first visualization component over the second visualization component, causing the first visualization component to push the second visualization component, or the like.

The process 400 includes an operation 414 to move the first visualization component based on the movement interaction rule, the location, and the user selection. The process 400 may include an operation to display, in response to identifying a second user interaction with an empty portion of the user interface in the layout edit mode, a control to add a new visualization component. In some examples, the process 400 includes inserting, in response to identifying a second user interaction with an empty portion of the user interface in the layout edit mode between two visualization components, a new blank row. The process 400 may include displaying on the user interface, before moving the first visualization component, a visual representation of a resulting state of the user interface after moving the first visualization component. For example, a future location of the first visualization component may be outlined, displayed in shade or color, with a dotted line, at a level of transparency, etc.

### Machine Architecture

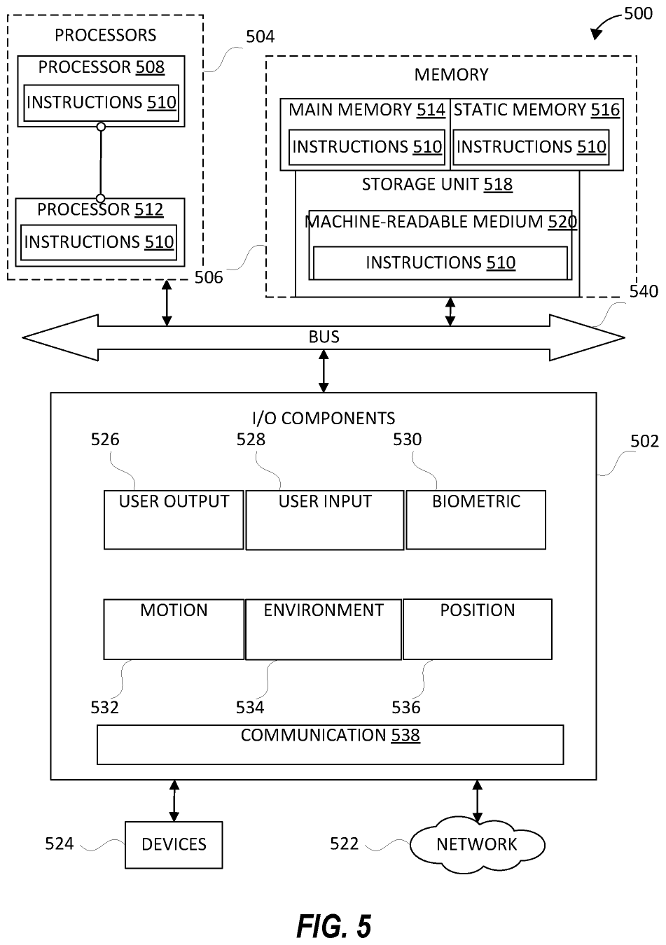

FIG. 5 is a diagrammatic representation of the machine 500 within which instructions 510 (e.g., software, a program, an application, an applet, an application, or other executable code) for causing the machine 500 to perform any one or more of the methodologies discussed herein may be executed. For example, the instructions 510 may cause the machine 500 to execute any one or more of the methods described herein. The instructions 510 transform the general, non-programmed machine 500 into a particular machine 500 programmed to carry out the described and illustrated functions in the manner described. The machine 500 may operate as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 510, sequentially or otherwise, that specify actions to be taken by the machine 500. Further, while only a single machine 500 is illustrated, the term “machine” shall also be taken to include a collection of machines that individually or jointly execute the instructions 510 to perform any one or more of the methodologies discussed herein. The machine 500, for example, may comprise the member client device 102 or any one of a number of server devices forming part of the experience analytics server 116. In some examples, the machine 500 may also comprise both client and server systems, with certain operations of a particular method or algorithm being performed on the server-side and with certain operations of the particular method or algorithm being performed on the client-side.

The machine 500 may include processors 504, memory 506, and input/output I/O components 502, which may be configured to communicate with each other via a bus 540. In an example, the processors 504 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 508 and a processor 512 that execute the instructions 510. The term “processor” is intended to include multi-core processors that may comprise two or more independent processors (sometimes referred to as “cores”) that may execute instructions contemporaneously. Although FIG. 5 shows multiple processors 504, the machine 500 may include a single processor with a single-core, a single processor with multiple cores (e.g., a multi-core processor), multiple processors with a single core, multiple processors with multiples cores, or any combination thereof.

The memory 506 includes a main memory 514, a static memory 516, and a storage unit 518, both accessible to the processors 504 via the bus 540. The main memory 506, the static memory 516, and storage unit 518 store the instructions 510 embodying any one or more of the methodologies or functions described herein. The instructions 510 may also reside, completely or partially, within the main memory 514, within the static memory 516, within machine-readable medium 520 within the storage unit 518, within at least one of the processors 504 (e.g., within the processor's cache memory), or any suitable combination thereof, during execution thereof by the machine 500.

The I/O components 502 may include a wide variety of components to receive input, provide output, produce output, transmit information, exchange information, capture measurements, and so on. The specific I/O components 502 that are included in a particular machine will depend on the type of machine. For example, portable machines such as mobile phones may include a touch input device or other such input mechanisms, while a headless server machine will likely not include such a touch input device. It will be appreciated that the I/O components 502 may include many other components that are not shown in FIG. 5. In various examples, the I/O components 502 may include user output components 526 and user input components 528. The user output components 526 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 528 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 502 may include biometric components 530, motion components 532, environmental components 534, or position components 536, among a wide array of other components. For example, the biometric components 530 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 532 include acceleration sensor components (e.g., accelerometer), gravitation sensor components, rotation sensor components (e.g., gyroscope).

The environmental components 534 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the member client device 102 may have a camera system comprising, for example, front cameras on a front surface of the member client device 102 and rear cameras on a rear surface of the member client device 102. The front cameras may, for example, be used to capture still images and video of a user of the member client device 102 (e.g., “selfies”). The rear cameras may, for example, be used to capture still images and videos in a more traditional camera mode. In addition to front and rear cameras, the member client device 102 may also include a 360° camera for capturing 360° photographs and videos.

Further, the camera system of a member client device 102 may include dual rear cameras (e.g., a primary camera as well as a depth-sensing camera), or even triple, quad or penta rear camera configurations on the front and rear sides of the member client device 102. These multiple cameras systems may include a wide camera, an ultra-wide camera, a telephoto camera, a macro camera and a depth sensor, for example.

The position components 536 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 502 further include communication components 538 operable to couple the machine 500 to a network 522 or devices 524 via respective coupling or connections. For example, the communication components 538 may include a network interface component or another suitable device to interface with the network 522. In further examples, the communication components 538 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 524 may be another machine or any of a wide variety of peripheral devices (e.g., a peripheral device coupled via a USB).

Moreover, the communication components 538 may detect identifiers or include components operable to detect identifiers. For example, the communication components 538 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 538, such as location via Internet Protocol (IP) geolocation, location via Wi-Fi® signal triangulation, location via detecting an NFC beacon signal that may indicate a particular location, and so forth.

The various memories (e.g., main memory 514, static memory 516, and memory of the processors 504) and storage unit 518 may store one or more sets of instructions and data structures (e.g., software) embodying or used by any one or more of the methodologies or functions described herein. These instructions (e.g., the instructions 510), when executed by processors 504, cause various operations to implement the disclosed examples.

The instructions 510 may be transmitted or received over the network 522, using a transmission medium, via a network interface device (e.g., a network interface component included in the communication components 538) and using any one of several well-known transfer protocols (e.g., hypertext transfer protocol (HTTP)). Similarly, the instructions 510 may be transmitted or received using a transmission medium via a coupling (e.g., a peer-to-peer coupling) to the devices 524.

### Software Architecture

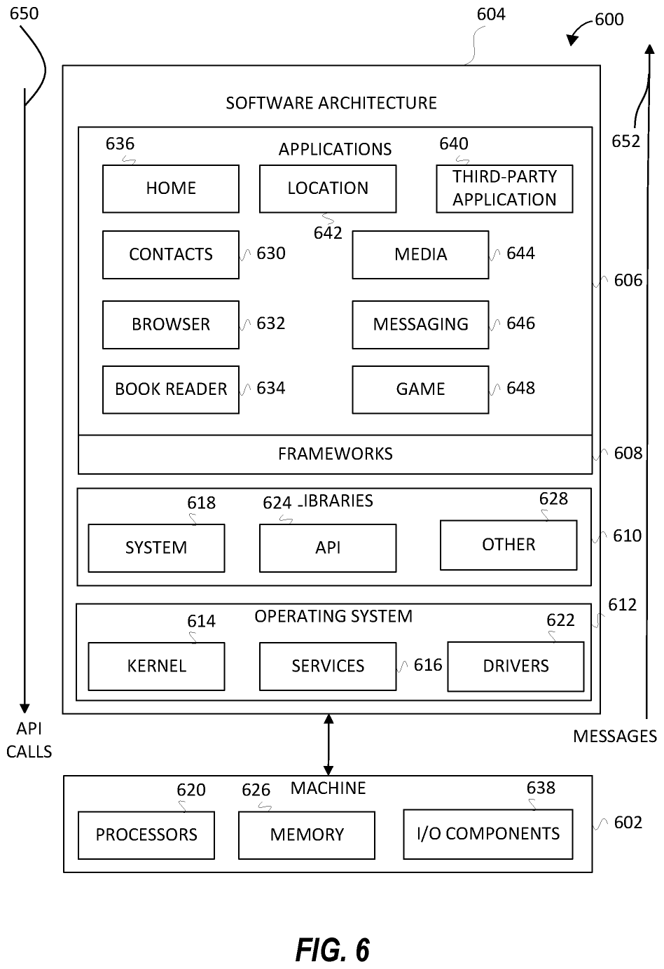

FIG. 6 is a block diagram 600 illustrating a software architecture 604, which can be installed on any one or more of the devices described herein. The software architecture 604 is supported by hardware such as a machine 602 that includes processors 620, memory 626, and I/O components 638. In this example, the software architecture 604 can be conceptualized as a stack of layers, where each layer provides a particular functionality. The software architecture 604 includes layers such as an operating system 612, libraries 610, frameworks 608, and applications 606. Operationally, the applications 606 invoke API calls 650 through the software stack and receive messages 652 in response to the API calls 650.

The operating system 612 manages hardware resources and provides common services. The operating system 612 includes, for example, a kernel 614, services 616, and drivers 622. The kernel 614 acts as an abstraction layer between the hardware and the other software layers. For example, the kernel 614 provides memory management, processor management (e.g., scheduling), component management, networking, and security settings, among other functionalities. The services 616 can provide other common services for the other software layers. The drivers 622 are responsible for controlling or interfacing with the underlying hardware. For instance, the drivers 622 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 610 provide a common low-level infrastructure used by the applications 606. The libraries 610 can include system libraries 618 (e.g., C standard library) that provide functions such as memory allocation functions, string manipulation functions, mathematic functions, and the like. In addition, the libraries 610 can include API libraries 624 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 610 can also include a wide variety of other libraries 628 to provide many other APIs to the applications 606.

The frameworks 608 provide a common high-level infrastructure that is used by the applications 606. For example, the frameworks 608 provide various graphical user interface (GUI) functions, high-level resource management, and high-level location services. The frameworks 608 can provide a broad spectrum of other APIs that can be used by the applications 606, some of which may be specific to a particular operating system or platform.

In an example, the applications 606 may include a home application 636, a contacts application 630, a browser application 632, a book reader application 634, a location application 642, a media application 644, a messaging application 646, a game application 648, and a broad assortment of other applications such as a third-party application 640. The applications 606 are programs that execute functions defined in the programs. Various programming languages can be employed to create one or more of the applications 606, structured in a variety of manners, such as object-oriented programming languages (e.g., Objective-C, Java, or C++) or procedural programming languages (e.g., C or assembly language). In a specific example, the third-party application 640 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 640 can invoke the API calls 650 provided by the operating system 612 to facilitate functionality described herein.

### User Interfaces

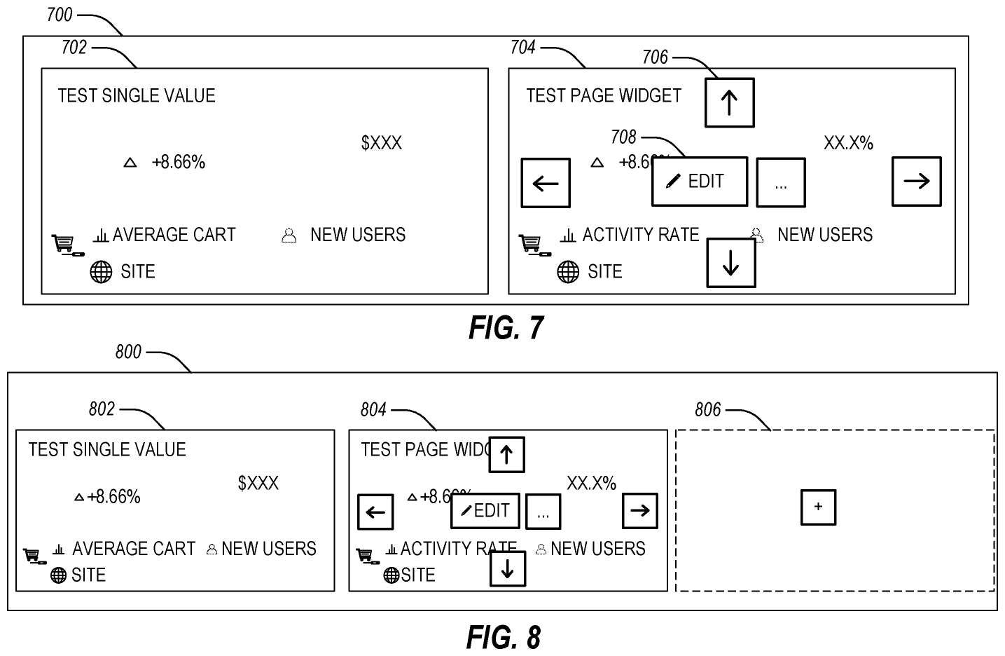

FIGS. 7-10 are example user interfaces showing the systems and techniques described herein, in accordance with some examples.

FIG. 7 illustrates an example user interface 700 with two visualization components, 702 and 704. The user interface 700 is shown in a layout edit mode. The layout edit mode may prevent interactions with aspects of the visualization components, while allowing interactions with control mechanisms, such as 706 or 708. The particular state of FIG. 7 shows the user interface 700 where a user is interacting with the visualization component 704 (and not the visualization component 702). Because of this user interaction (e.g., in response to it), the visualization component 704 shows the control mechanisms. The user interaction may include a mouse hover over the visualization component 704, a long press (e.g., on a touchscreen) on the visualization component 704, a right mouse click on the visualization component 704, a space bar press, etc.

The control mechanisms may be overlaid on the visualization component 704. In some examples, a visual appearance of aspects of the visualization component 704 may be changed, such as adding fading, transparency, changing color, etc. The control mechanisms displayed as overlaid on the visualization component 704 may disappear when the user interaction is removed, ceases, or in response to a second user interaction (e.g., a user interaction with a different part of the user interface 700, such as the visualization component 702). The control mechanisms may include a movement control mechanism 706, for example to cause the visualization component 704 to move, in this example, up. The control mechanisms may include an edit controller 708, which may be used to edit content of the visualization component 704. Other control mechanisms may be provided, such as to delete the visualization component 704, refresh the visualization component 704, change out the visualization component 704 for a new visualization component, or the like.

In an example, the user interface 700 displays a dashboard including one or more widgets (e.g., a visualization component), which may represent different visualization types (e.g., single numeric value, line chart, page visualizations, etc.). The user interface 700 may enable collaboration between customers via sharing. For example, a customer may spend time building a dashboard and then share it with one or more other users or companies, such as with a single click.

The user interface 700 includes an arrow-based movement system, which may be called a click and swap user interface. When a user interacts with a visualization component, such as by hovering on the visualization component, four directional arrows may be presented to cause movement of the visualization component. A movement may result in the visualization component moving to a certain location when the location is free (e.g., no other widget occupying that position) or being swapped with another visualization component. The movements may be dictated by movement rules, which are explained in more detail below.

An example code for a grid represented in the user interface 700 may include:

```
<div>
  <grid-wrapper edit-mode=“true”>
    <grid-item item-id=“0” x=“0” y=“0” rows=“1” cols=“1”>
      <!-- Any HTML element -->
    </grid-item>
    <grid-item item-id=“1” x=“1” y=“0” rows=“1” cols=“1”>
      <!-- Any HTML element -->
    </grid-item>
  </grid-wrapper>
</div>
```

The above code may be used to divide available space into a grid layout of equally sized columns (e.g., four columns), place items inside the grid according to their x and y coordinates, size items according to the their rows and column attributes (in some examples an item spans over multiple lines or columns), show directional arrows on top of the grid items based on user interaction (e.g., hover) for causing movement of a visualization component, show a selectable indication (e.g., a plus in a box) on an empty space in the grid to allow a user to add an item to the grid, a selectable indication between items to allow a user to add an item between grid items, or the like.

In an example, each item in the grid may notify a grid-wrapper when it is added to or removed from Document Object Model (DOM). For example, a callback may be triggered when an item is added to the DOM. Similarly, when an item is removed from the DOM, a disconnect callback may be triggered. For example, when an item is added, it may notify the parent (e.g., the grid-wrapper), passing to the grid-wrapper the item's attributes (e.g., position, dimensions, or a reference to its HTML element). This allows the grid-wrapper to construct a state. The state may be a 2D matrix used to represent items on the grid with their positions and dimensions. The state may include object representations of the items positioned on the matrix based on their positions on the view.

The state may be directly linked to the view, where each time the state changes, a re-render of the view is triggered. In an example, when an item A is selected to move to the right, and there is no item in the end position, item A's corresponding representation object on the state matrix may be moved from (line-y, col-x) to (line-y, col-x+1). When the state changes, a re-render of the view is triggered, placing the corresponding item accordingly on the view. These actions may be handled by a state machine, and when an item is moved on top of an existing item, then they may swap or push. A user may select a movement strategy to control movement rule priority or a default priority may be used.

In some examples, the grid may be used to resize visualization components, for example up to a horizontal size of up to the number of columns of the grid. When resizing a visualization component, the grid-wrapper may check for presence of other visualization components, and prevent resizing when a visualization component exists in a destination column.

FIG. 8 illustrates an example user interface 800 with two visualization components, 802 and 804, as well as an empty cell 806. The user interface 800 is shown in a layout edit mode. The particular state of FIG. 8 shows the user interface 800 where a user is interacting with the empty cell 806 (e.g., hovering over it with a mouse, long touching on a touchscreen, holding a left click on a mouse, right clicking with a mouse, etc.). The empty cell 806 is shown with an example dotted outline, but may be shown in other visual presentations. The empty cell 806 includes a selectable indication (e.g., a plus button in a box), which when selected, causes a new visualization component to be created. When a user interacts with the selectable indication, a new user interface component may be displayed, allowing the user to select aspects or types of visualization component to add to the user interface 800 at the location of the empty cell 806. In some examples, the added visualization component may be larger or smaller than the size shown for the empty cell 806. When the added visualization component is larger, one or more of the visualization components 802 or 804 may be moved in response.

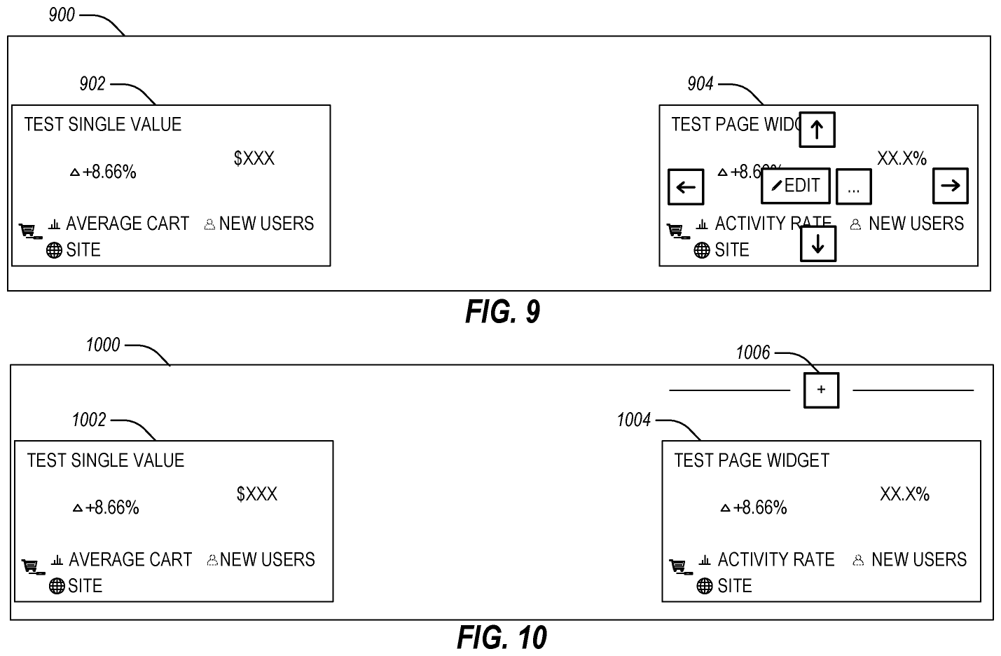

FIG. 9 illustrates an example user interface 900 with two visualization components, 902 and 904, as well as empty space between the two visualization components 902 and 904. The user interface 900 is shown in a layout edit mode. In an example, the user interface 900 is a resulting state of an interaction with a “move right” control mechanism on the visualization component 704 of user interface 700 of FIG. 7. FIG. 9 illustrates an example similar to the user interface 800 of FIG. 8, but where the user is not interacting with space between the visualization components 902 and 904, and therefore the empty space of the user interface 900 does not show a visual presentation or selectable indication, as is shown in the empty cell 806 visual presentation of FIG. 8.

FIG. 10 illustrates an example user interface 1000 with two visualization components, 1002 and 1004, as well as an add row control mechanism 1006 located above the visualization component 1004. The user interface 1000 is shown in a layout edit mode. In an example, the user interface 1000 presents the add row control mechanism 1006 in response to a user interaction with a portion of the user interface 1000 on or near a location of the add row control mechanism 1006 (e.g., between the visualization component 1004 and at least one of another visualization component above the visualization component 1004, a top of a screen, a top of the user interface 1000, or the like.

The add row control mechanism 1006 may be used to create a new blank row above (or below in other examples) the visualization component 1004. In response to selection of the add row control mechanism 1006, the new row may be created, which may cause the visualization components 1002 and 1004 to move down in the user interface 1000. Selection of the add row control mechanism 1006 may cause the user interface 1000 to display a new user interface component, which allows a user to select a new visualization component to add to the user interface 1000 in the new row. While the add row control mechanism 1006 is shown above the visualization component 1004, it may appear over the visualization component 1002 or over the empty space between the two visualization components 1002 and 1004.

In some examples, such as for users who want further customization, some aspects shown in any of FIGS. 7-10 may be overridden. For example, attributes such as responsiveness, edit-mode, number of columns, gaps, each unit width or height, or the like may be overridden.

### Block Diagrams

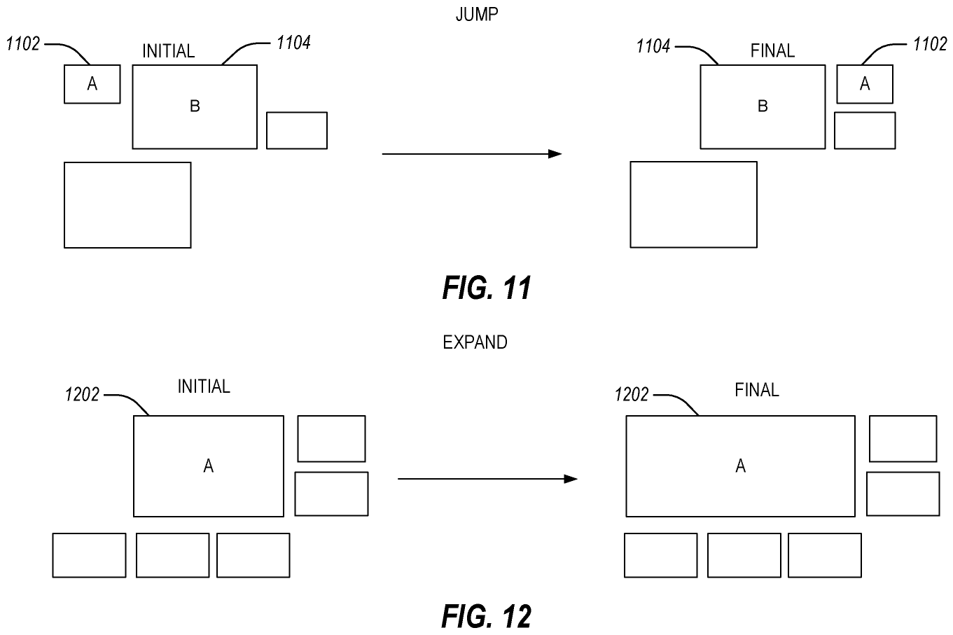

FIGS. 11-15 are example block diagrams showing movement interaction rules in accordance with some examples.

FIG. 11 shows a block diagram where a visualization component 1102 is moved to the right, and jumps over visualization component 1104 according to a movement interaction rule. The visualization component 1102 is moved to the right, but because the visualization component 1104 occupies a position immediately to the right of the visualization component 1102, a movement rule is invoked to cause the visualization component 1102 to jump over the visualization component 1104 and land in an empty location to the right of the visualization component 1104.

FIG. 12 shows a block diagram where a visualization component 1202 is expanded. An expand control mechanism may be selected on the visualization component 1202, causing the visualization component 1202 to expand to the left, occupying an additional column, for example. The visualization component 1202 may be prevented from expanding in examples where another visualization component is present in a location where the visualization component 1202 would be expanded to. For example, The visualization component 1202 may not be expandable to the right or down in FIG. 12, because there are one or more other visualization components present in those locations. A control mechanism to allow expansion may be visually limited to showing options that are possible (e.g., in FIG. 12, expanding visualization component 1202 to the left only). In examples where no expansions are possible, a control mechanism to allow expansion for a visualization component may be suppressed, visually displayed in a manner that indicates it is not usable (e.g., grayed out), removed, etc.

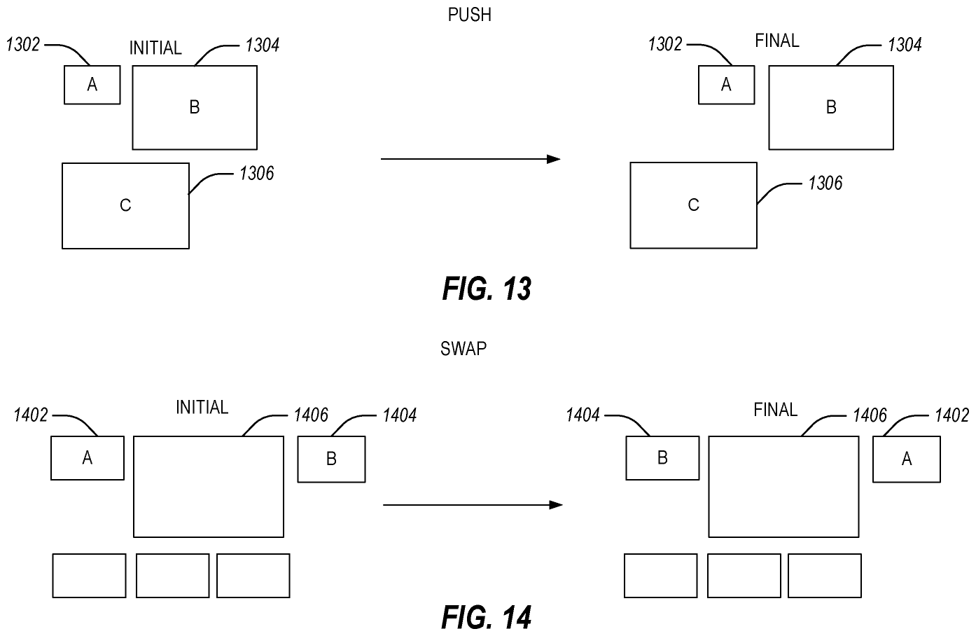

FIG. 13 shows a block diagram where a visualization component 1302 moves and pushes a visualization component 1304 according to a movement interaction rule. A control mechanism overlaid on the visualization component 1302 may selected to move the visualization component 1302 to the right. The movement interaction rule may then cause the visualization component 1304 to move to the right as well, as can be seen in FIG. 13. The visualization component 1304 starts partially overlapped in a horizontal direction with visualization component 1306, and ends entirely to the right of the visualization component 1306 horizontally. In this way, selection of the movement control mechanism on the visualization component 1302 causes both the visualization component 1302 and the visualization component 1304 to move to the right.

FIG. 14 shows a block diagram where a visualization component 1402 swaps positions with visualization component 1404 according to a movement interaction rule. The visualization component 1402 may be moved in response to user selection of a control mechanism, such as to move the visualization component 1402 to the right. The visualization component 1402 may be swapped with the visualization component 1404 by moving the visualization component 1402 to the right and the visualization component 1404 to the left. The visualization components 1402 and 1404 may be swapped in response to a determination, after selection of a control mechanism to move the visualization component 1402 to the right, that a slot or all slots to the right of the visualization component 1402 are occupied by one or more other visualization components. In the example shown in FIG. 14, the visualization component 1402 may not be moved to the right because visualization components 1404 and 1406 occupy all slots to the right. In some examples, such as when there is another slot to the right of the visualization component 1404 in the initial view, the visualization component 1402 may be moved there. In other examples, the visualization component 1402 is not moved past two visualization components, and instead the visualization components 1402 and 1404 are swapped, even if an empty slot exists to the right of the visualization component 1404.

Movement interaction rules may be selected automatically, such as according to a current layout, a default rule priority, or based on content of the visualization components. In some examples, movement interaction rules may be customized (e.g., a user may select one or more movement interaction rules to prioritize or use in one or more particular situations, a user may overrule a default rule, etc.). For automatic rule priority, an example includes prioritizing moving a visualization component to an adjacent empty space, when available, moving a relatively smaller visualization component past a larger visualization component (e.g., jumping) rather than swapping or pushing the larger visualization component, prioritizing swapping over pushing, prioritizing swapping over moving a visualization component past two other visualization components, preventing expansion of a visualization component when expansion would cause pushing another visualization component, or the like.

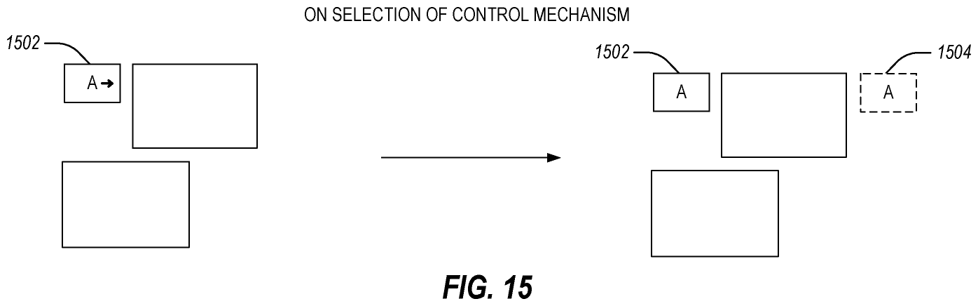

FIG. 15 shows a block diagram illustrating a destination for a visualization component 1502. The destination is shown by providing a visual representation 1504 of the visualization component 1502. In the example of FIG. 15, the visualization component 1502 is shown with the visual representation 1504 reflecting a destination caused by jumping another visualization component. The visual representation 1504 may be used for other movement interaction rules, such as swapping, pushing, expanding, etc. In cases where a selection of a control mechanism on the visualization component 1502 results in the movement of two or more visualization components (e.g., the visualization component 1502 and at least one other visualization component), two or more visual representations may be displayed. In some examples, this may result in a visual representation overlaid on a visualization component (e.g., in swapping, the visual representations may be displayed in the swapped positions overlaid on the pre-movement visualization components).

The visual representation 1504 may include a partially transparent version of the visualization component 1502, have a dotted outline, include a color or shape change from the visualization component 1502, blink or flash, or the like. The visual representation 1504 may be displayed when a user interacts with a control mechanism on the visualization component 1502, such as when the user hovers, long presses, right clicks, click and holds, etc. over or on the control mechanism. When the user interaction ends (e.g., without selecting the control mechanism, such as without clicking on the control mechanism), the visual representation 1504 may be removed from the user interface. When the user interaction includes selecting the control mechanism on the visualization component 1502, the visualization component 1502 may be shown or illustrated moving to the visual representation 1504, eventually replacing the visual representation 1504 on the user interface in some examples.

The jump shown in FIG. 11, the expand shown in FIG. 12, the push shown in FIG. 13, and the swap shown in FIG. 14, and the visual representation shown in FIG. 15 are illustrated using horizontal changes to a visualization component for ease of understanding, but may be used with vertical changes instead of or in addition to the horizontal changes.

### Glossary

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 1004 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

Example 1 is a method comprising: rendering a user interface in a layout edit mode, the user interface including a dashboard having a plurality of visualization components; identifying a user interaction with a first visualization component of the plurality of visualization components; in response to identifying the user interaction, displaying a location control interface overlaid on the first visualization component; receiving a user selection of a control mechanism of the location control interface; determining that a second visualization component of the plurality of visualization components is in a location corresponding to where the user selection would cause the first visualization component to move; selecting a movement interaction rule of a plurality of movement interaction rules to apply to the first visualization component; and moving the first visualization component based on the movement interaction rule, the location, and the user selection.

In Example 2, the subject matter of Example 1 includes, wherein the movement interaction rule specifies a number of equally sized column locations for placement of the plurality of visualization components.

In Example 3, the subject matter of Example 2 includes, wherein selection of a resize control mechanism of the location control interface causes the first visualization component to be sized to occupy at least two of the equally sized column locations.

In Example 4, the subject matter of Example 3 includes, wherein the resize control mechanism is disabled on the location control interface when the second visualization component occupies one of the at least two of the equally sized column locations.

In Example 5, the subject matter of Examples 1-4 includes, wherein the control mechanism includes a directional arrow.

In Example 6, the subject matter of Examples 1-5 includes, in response to identifying a second user interaction with an empty portion of the user interface in the layout edit mode, displaying a control to add a new visualization component.

In Example 7, the subject matter of Examples 1-6 includes, in response to identifying a second user interaction with an empty portion of the user interface in the layout edit mode between two visualization components, inserting a new blank row.

In Example 8, the subject matter of Examples 1-7 includes, before moving the first visualization component, displaying, on the user interface, a visual representation of a resulting state of the user interface after moving the first visualization component.

In Example 9, the subject matter of Examples 1-8 includes, wherein the user interaction is a mouse hover, a long press on a touchscreen, or a right mouse click, and wherein the user selection is a left mouse click or touch selection on a touchscreen.

In Example 10, the subject matter of Examples 1-9 includes, wherein the plurality of movement interaction rules include at least one of swapping the first visualization component with the second visualization component, passing the first visualization component over the second visualization component, or causing the first visualization component to push the second visualization component.

Example 11 is a computing apparatus, the computing apparatus comprising: a processor; and a memory storing instructions that, when executed by the processor, configure the apparatus to: render a user interface in a layout edit mode, the user interface including a dashboard having a plurality of visualization components; identify a user interaction with a first visualization component of the plurality of visualization components; display, in response to identifying the user interaction, a location control interface overlaid on the first visualization component; receive a user selection of a control mechanism of the location control interface; determine that a second visualization component of the plurality of visualization components is in a location corresponding to where the user selection would cause the first visualization component to move; select a movement interaction rule of a plurality of movement interaction rules to apply to the first visualization component; and move the first visualization component based on the movement interaction rule, the location, and the user selection.

In Example 12, the subject matter of Example 11 includes, wherein the movement interaction rule specifies a number of equally sized column locations for placement of the plurality of visualization components.

In Example 13, the subject matter of Example 12 includes, wherein selection of a resize control mechanism of the location control interface causes the first visualization component to be sized to occupy at least two of the equally sized column locations.

In Example 14, the subject matter of Example 13 includes, wherein the resize control mechanism is disabled on the location control interface when the second visualization component occupies one of the at least two of the equally sized column locations.

In Example 15, the subject matter of Examples 11-14 includes, wherein the instructions, when executed by the processor, cause the processor to display, in response to identifying a second user interaction with an empty portion of the user interface in the layout edit mode, a control to add a new visualization component.

In Example 16, the subject matter of Examples 11-15 includes, wherein the instructions, when executed by the processor, cause the processor to display on the user interface, before moving the first visualization component, a visual representation of a resulting state of the user interface after moving the first visualization component.

In Example 17, the subject matter of Examples 11-16 includes, wherein the user interaction is a mouse hover, a long press on a touchscreen, or a right mouse click, and wherein the user selection is a left mouse click or touch selection on a touchscreen.

In Example 18, the subject matter of Examples 11-17 includes, wherein the plurality of movement interaction rules include at least one of swapping the first visualization component with the second visualization component, passing the first visualization component over the second visualization component, or causing the first visualization component to push the second visualization component.

Example 19 is at least one non-transitory machine-readable medium including instructions, which when executed by processing circuitry, cause the processing circuitry to perform operations to: render a user interface in a layout edit mode, the user interface including a dashboard having a plurality of visualization components; identify a user interaction with a first visualization component of the plurality of visualization components; display, in response to identifying the user interaction, a location control interface overlaid on the first visualization component; receive a user selection of a control mechanism of the location control interface; determine that a second visualization component of the plurality of visualization components is in a location corresponding to where the user selection would cause the first visualization component to move; select a movement interaction rule of a plurality of movement interaction rules to apply to the first visualization component; and move the first visualization component based on the movement interaction rule, the location, and the user selection.

In Example 20, the subject matter of Example 19 includes, wherein the plurality of movement interaction rules include at least one of swapping the first visualization component with the second visualization component, passing the first visualization component over the second visualization component, or causing the first visualization component to push the second visualization component.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A method comprising:
rendering a user interface in a layout edit mode, the user interface including a dashboard having a plurality of visualization components;
identifying a user interaction with a first visualization component of the plurality of visualization components;
in response to identifying the user interaction, displaying a location control interface overlaid on the first visualization component;
receiving a user selection of a control mechanism of the location control interface;
determining that a second visualization component of the plurality of visualization components is in a location corresponding to where the user selection would cause the first visualization component to move;
selecting a movement interaction rule of a plurality of movement interaction rules to apply to the first visualization component; and
moving the first visualization component based on the movement interaction rule, the location, and the user selection.

2. The method of claim 1, wherein the movement interaction rule specifies a number of equally sized column locations for placement of the plurality of visualization components.

3. The method of claim 2, wherein selection of a resize control mechanism of the location control interface causes the first visualization component to be sized to occupy at least two of the equally sized column locations.

4. The method of claim 3, wherein the resize control mechanism is disabled on the location control interface when the second visualization component occupies one of the at least two of the equally sized column locations.

5. The method of claim 1, wherein the control mechanism includes a directional arrow.

6. The method of claim 1, further comprising, in response to identifying a second user interaction with an empty portion of the user interface in the layout edit mode, displaying a control to add a new visualization component.

7. The method of claim 1, further comprising, in response to identifying a second user interaction with an empty portion of the user interface in the layout edit mode between two visualization components, inserting a new blank row.

8. The method of claim 1, further comprising, before moving the first visualization component, displaying, on the user interface, a visual representation of a resulting state of the user interface after moving the first visualization component.

9. The method of claim 1, wherein the user interaction is a mouse hover, a long press on a touchscreen, or a right mouse click, and wherein the user selection is a left mouse click or touch selection on a touchscreen.

10. The method of claim 1, wherein the plurality of movement interaction rules include at least one of swapping the first visualization component with the second visualization component, passing the first visualization component over the second visualization component, or causing the first visualization component to push the second visualization component.

11. A computing apparatus, the computing apparatus comprising:
a processor; and
a memory storing instructions that, when executed by the processor, configure the apparatus to:
render a user interface in a layout edit mode, the user interface including a dashboard having a plurality of visualization components;
identify a user interaction with a first visualization component of the plurality of visualization components;
display, in response to identifying the user interaction, a location control interface overlaid on the first visualization component;
receive a user selection of a control mechanism of the location control interface;
determine that a second visualization component of the plurality of visualization components is in a location corresponding to where the user selection would cause the first visualization component to move;
select a movement interaction rule of a plurality of movement interaction rules to apply to the first visualization component; and
move the first visualization component based on the movement interaction rule, the location, and the user selection.

12. The computing apparatus of claim 11, wherein the movement interaction rule specifies a number of equally sized column locations for placement of the plurality of visualization components.

13. The computing apparatus of claim 12, wherein selection of a resize control mechanism of the location control interface causes the first visualization component to be sized to occupy at least two of the equally sized column locations.

14. The computing apparatus of claim 13, wherein the resize control mechanism is disabled on the location control interface when the second visualization component occupies one of the at least two of the equally sized column locations.

15. The computing apparatus of claim 11, wherein the instructions, when executed by the processor, cause the processor to display, in response to identifying a second user interaction with an empty portion of the user interface in the layout edit mode, a control to add a new visualization component.

16. The computing apparatus of claim 11, wherein the instructions, when executed by the processor, cause the processor to display on the user interface, before moving the first visualization component, a visual representation of a resulting state of the user interface after moving the first visualization component.

17. The computing apparatus of claim 11, wherein the user interaction is a mouse hover, a long press on a touchscreen, or a right mouse click, and wherein the user selection is a left mouse click or touch selection on a touchscreen.

18. The computing apparatus of claim 11, wherein the plurality of movement interaction rules include at least one of swapping the first visualization component with the second visualization component, passing the first visualization component over the second visualization component, or causing the first visualization component to push the second visualization component.

19. At least one non-transitory machine-readable medium including instructions, which when executed by processing circuitry, cause the processing circuitry to perform operations to:
render a user interface in a layout edit mode, the user interface including a dashboard having a plurality of visualization components;
identify a user interaction with a first visualization component of the plurality of visualization components;
display, in response to identifying the user interaction, a location control interface overlaid on the first visualization component;
receive a user selection of a control mechanism of the location control interface;
determine that a second visualization component of the plurality of visualization components is in a location corresponding to where the user selection would cause the first visualization component to move;
select a movement interaction rule of a plurality of movement interaction rules to apply to the first visualization component; and
move the first visualization component based on the movement interaction rule, the location, and the user selection.

20. The at least one machine-readable medium of claim 19, wherein the plurality of movement interaction rules include at least one of swapping the first visualization component with the second visualization component, passing the first visualization component over the second visualization component, or causing the first visualization component to push the second visualization component.
